(19) United States
(12) Patent Application Publication
(10) Pub. No.: US 2016/0221316 A1
(43) Pub. Date: Aug. 4, 2016

(54) TOUCH LAYER FOR MOBILE COMPUTING DEVICE

(71) Applicant: Tactus Technology, Inc., Fremont, CA (US)

(72) Inventors: Micah Yairi, San Carlos, CA (US); Radhakrishnan Parthasarathy, Palo Alto, CA (US)

(21) Appl. No.: 14/996,087

(22) Filed: Jan. 14, 2016

Related U.S. Application Data
(60) Provisional application No. 62/103,466, filed on Jan. 14, 2015.

(51) Int. Cl. B32B 27/40; G06F 3/041

(52) U.S. Cl. CPC B32B 27/40; G06F 3/041; B32B 2255/10; B32B 2255/26; B32B 2307/56; B32B 2307/51; B32B 2307/762; B32B 2457/208

(57) ABSTRACT

A touch layer for a mobile computing device includes a substrate defining a surface, a first polymer layer and a second polymer layer. The first polymer layer includes a first modulus and is arranged across the surface. The second polymer layer includes a polymer of a second modulus less than the first modulus and is arranged across the first polymer layer opposite the substrate. The touch layer also includes a low-friction coating applied across the second polymer layer opposite the first polymer layer. The touch layer exhibits a self-repair property to repair damage to one of the polymer layers or the low-friction layer. The self repair may be implemented by material flow or diffusion, heat activated or time-release, and may return a surface of the touch display to near its original condition.

### CROSS-REFERENCE TO RELATED APPLICATIONS

This application claims the benefit of U.S. Provisional Application No. 62/103,466, filed 14 Jan. 2015, the entirety of which is incorporated by reference herein.

### TECHNICAL FIELD

This invention relates generally to the field of touch-sensitive displays, and more specifically to touch layer for a mobile computing device with a touch-sensitive display.

### BRIEF DESCRIPTION OF THE FIGURES

FIG. 1 is a schematic representation of a touch layer of the invention;

FIG. 2 is a schematic representation of one variation of the touch layer;

FIG. 3 is a schematic representation of one variation of the touch layer;

FIG. 4 is a schematic representation of one variation of the touch layer;

FIG. 5 is a flowchart representation of one application of the touch layer;

FIG. 6 is a flowchart representation of one application of the touch layer;

FIG. 7 is a flowchart representation of one implementation of the touch layer; and

FIG. 8 is a schematic representation of one implementation of the touch layer.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

As shown in FIG. 1, a touch layer for a mobile computing device includes: a substrate defining a surface; a first polymer layer including a polymer of a first modulus (i.e., elastic modulus) and arranged across the surface; a second polymer layer including a polymer of a second modulus less than or greater than the first modulus and arranged across the first polymer layer opposite the substrate; and a low-friction coating applied across the second polymer layer opposite the first polymer layer. Hence, the first modulus of the first polymer layer may be less or greater than the second modulus of the second polymer layer.

A polymer layer may be comprised of any of several different types of material. For example, a polymer material may include an elastomer, rigid layer, gel, and/or hybrid. A hybrid material may include filled elastomers with either nanoparticles (such as Aluminum oxide, silica, or silicon oxide) or nano-clays (such as aluminum silicate or laponite).

Generally, the touch layer is arranged over or encapsulates a touch sensor, a display, and/or a touchscreen of a mobile computing device, such as a smartphone or a tablet. The touch layer defines an interaction surface through which the touch sensor captures user inputs, such inputs entered with a finger or with a stylus. The touch layer can thus protect the touch sensor and/or the display, such as from fluid or dirt ingress or impact by a finger, a stylus, or other device, implement, or surface, and the touch layer can provide a suitably smooth and flat surface enabling substantially unimpeded user interactions (e.g., inputs). The touch layer can also be substantially transparent, thereby enabling transmission of light output from the display to a user with suitably minimal internal reflection, refraction, and/or diffraction. However, the touch layer can be arranged over or encapsulate a touch sensor, a display, and/or a touchscreen of any other suitable device.

The arrangement and material selection of components within the touch layer can facilitate ‘self-healing’ capabilities. For example, the first and/or the second polymer layers can be of a material with a low glass transition temperature that enables superficial damage (e.g., depressions, abrasions, and/or scratches, etc.) in the touch layer to diffuse when heated, such as by sunlight or by heat output by a battery and/or processor within the corresponding device.

The materials used to implement the first polymer layer and the second polymer layer with a low glass transition temperature may also be such that when heat is applied, the materials recover. To recover, a polymer layer may first flow when heated. The flow may allow for superficial damage to be filled or repaired with material to near its original state. The original state may be flat and smooth without depressions, abrasions, and scratches. As such, when a first polymer (or second polymer) layer with a low glass transition temperature is heated, the material in the first polymer (or second polymer) may soften and flow to fill in the depressions, abrasions, and scratches, so that the depressions, abrasions and scratches are removed or nearly entirely removed and therefore in nearly in its original state.

Similarly, the first and/or the second polymer layers can be of a material that (mechanically) creeps, reflows, re-knits, or recovers over relatively short periods of time such that surface damage, such as impressions or scratches, is removed from the touch layer both during use (e.g., when touched by a user) and when sitting idle. For example, a groove having dimensions of 25 microns deep and 100 microns wide or 1 millimeter wide might recover in an hour, such that the groove would be removed. In another example, a tear having dimensions of 1 millimeter deep or one quarter of a millimeter deep and 100 microns wide might be repaired in one hour or one day. Furthermore, packets with un-cured polymer and/or low-friction material can be impregnated in the low-friction coating and/or in the second and/or first polymer layer, wherein wear or tear on the touch layer causes the packets to burst, releasing additional low-friction material to repair and reseal the adjacent surface. The elastic (e.g., minimally brittle) nature of materials in the touch layer can also withstand substantial impact and can therefore by substantially impervious to damage by, for example dropping on a hard surface.

In some instances, the first polymer layer or the second polymer layer, or both polymer layers, may be made of a self-adaptive composite. The self-adaptive composite can consist of micron-scale rubber balls that form a solid matrix. A self-adaptive composite can be manufactured by mixing two polymers and a solvent that evaporates when heated, leaving a porous mass of spheres. When cracked, the matrix quickly heals, and it returns to its original form after compression. In one particular implementation of a self-adaptive composite, tiny spheres of polyvinylidene fluoride (PVDF) encapsulate much of the liquid. The viscous polydimethylsiloxane (PDMS) further coats the entire surface. The spheres are extremely resilient, having thin shells deform easily. Their liquid contents enhance their viscoelasticity, a measure of their ability to absorb the strain and return to their original state, while the coatings keep the spheres together.

The spheres also have the freedom to slide past each other when compressed, but remain attached—

The substrate of the touch layer defines a surface. Generally, the substrate functions to define a rigid interface between a touch sensor and the first polymer layer such that the relatively elastic first polymer layer can be mounted over the touch sensor (or display or touchscreen). The substrate is also substantially transparent, thereby permitting transmission of light from the display and through the touch layer. For example, the substrate can be a cast or extruded planar sheet of a polymer material, such as poly(methyl methacrylate) (PMMA, or acrylic), polycarbonate, or silicone. Alternatively, the substrate can be a silicate glass, an alkali-aluminosilicate glass, or any other suitable material, such as described in U.S. Provisional Application No. 61/713,396, filed on 12 Oct. 2012, which is incorporated in its entity by this reference.

As described below, the substrate can be coupled to the touch sensor, display, and/or touchscreen of the corresponding mobile computing device. For example, the substrate can be adhered or chemically bonded over the touch sensor, such as over an exposed array of conductive traces and pads (e.g., electrodes) of a capacitive touch sensor. The substrate can alternatively be physically coextensive with or define a touch sensor. In one example, the substrate can include a PMMA sheet of uniform thickness (e.g., 0.5 mm) with conductive indium tungsten oxide (ITO) traces and capacitor pads deposited in perpendicular arrays across each side of the substrate, thereby defining a capacitive touch sensor. The substrate can alternatively include an array of microfluidic channels containing conductive fluid, wherein the fluid within the channels functions as deformable capacitive touch sensor electrodes and traces, such as described in U.S. Patent Application No. 61/727,071, filed on 15 Nov. 2012, which is incorporated in its entity by this reference. Yet alternatively, the substrate can include an array of silver wires that function as traces and electrode pads in a capacitive touch sensor.

The substrate can additionally or alternatively be physically coextensive with a display and/or a touchscreen (i.e., display and touch sensor assembly). However, the substrate can be of any other form or material and/or can be physically coextensive with or coupled to any other suitable component within a mobile computing device.

The touch layer may include a heating element. When engaged, the heating element may apply heat to the first polymer layer, the second polymer layer, or the low friction layer, or two more than one of these layers. When heat is applied, one or more of the first polymer layer, the second polymer layer, or the low friction layer may flow and self-repair, returning to near its original state. In some instances, when heat is applied, one or more of the first polymer layer, the second polymer layer, or the low friction layer may diffuse, resulting in self repair.

The heating element may be implemented in several ways. In some instances, an element may be implemented by a processor, resistor, display, or other circuitry element of the device over which the touch layer is positioned. When engaged to provide heat, the processor, resistor, display, or other circuitry element may provide heat that causes flow or diffusion, or both, resulting in self repair of the first polymer layer, the second polymer layer, or the low friction layer.

The heating element may be implemented as a transparent conductor. The transparent conductor may have a resistance value, and when a voltage is applied to the transparent conductor it may be generate heat. The heat may be sufficient to causes flow or diffusion, or both, resulting in self repair of the first polymer layer, the second polymer layer, or the low friction layer. The transparent conductor may be embedded within the first polymer layer, within the second polymer layer, or within the low friction layer. The transparent conductor may alternatively, or additionally, be positioned between the second polymer layer and the first polymer layer, between the first polymer layer and the low friction layer, or between the touch layer and the device upon which the touch layer is applied. The transparent conductor may be implemented in several forms, such as for example a silver nano-wire.

The heating element may be implemented as a touch sensor within the touch layer. When a voltage is applied to the touch sensor, the touch sensor may emit heat. The heat may be sufficient to cause flow or diffusion, or both, resulting in self repair of the first polymer layer, the second polymer layer, or the low friction layer. The touch sensor may be embedded within the first polymer layer, within the second polymer layer, or within the low friction layer. The touch sensor may alternatively, or additionally, be positioned between the second polymer layer and the first polymer layer, between the first polymer layer and the low friction layer, or between the touch layer and the device upon which the touch layer is applied.

The heating element may be implemented as an element embedded within a touch sensor, such as for example a nano-wire. When a voltage is applied to the nano-wire, the nano-wire may emit heat. The heat from the nano-wire may be sufficient to causes flow or diffusion, or both, resulting in self repair of the first polymer layer, the second polymer layer, or the low friction layer. The nano-wire heating element may be embedded within the first polymer layer, within the second polymer layer, or within the low friction layer. The nano-wire may alternatively, or additionally, be positioned between the second polymer layer and the first polymer layer, between the first polymer layer and the low friction layer, or between the touch layer and the device upon which the touch layer is applied.

Implementing a heating element as a nano-wire, or other extensible, thin and transparent element, has several advantages. The heating element may be flexible in its placement within the touch layer. For example, a heating element comprising an extensible, thin, transparent element such as a nano-wire (e.g., silver nano-wire) may be placed within a first polymer layer, within a second polymer layer, or between a second polymer layer and a first polymer layer or between a first polymer layer and a low-friction layer. Additionally, because such heating element would be transparent, an extensible, thin, transparent element such as a nano-wire could be used in transparent displays, and could therefore be used in touch layers positioned over a device display.

The first polymer layer of the touch layer includes a polymer of a first modulus and arranged across the surface of the substrate, and the second polymer layer of the touch layer includes a polymer of a second modulus less than the first modulus and arranged across the first polymer layer opposite the substrate. Generally, the first and second polymer layers function as an elastic panel over the substrate and the touch sensor (or display or touchscreen), the first and second polymer layers absorbing impacts and shielding the touch sensor from fluid or particulate ingress that may otherwise distort, damage, or inhibit operation of the touch sensor.

Generally, the first polymer layer, which has a greater elasticity (e.g., is less rigid or ‘softer’) than the second polymer layer functions as a buffer between the substrate and the second polymer layer. The first polymer layer can therefore provide a soft support for the second polymer layer, thus enabling the second polymer layer to deform into the first polymer layer in response to a relatively high-pressure input on the touch surface, such as from a pen or stylus. Furthermore, the second polymer layer, which is harder than the first polymer layer, can withstand scratches or other damage and thus exhibit greater wear resistance than, say, a layer of modulus comparable to the first polymer layer.

The first and second polymer layers can be of the same material, such as urethane, polyester, nylon, or any other suitable elastomeric and/or polymer material. The second polymer layer can exhibit great cross-linking between polymer chains than the first polymer layer such that the second polymer layer is ‘harder’ and/or less elastic than the first polymer layer. Alternatively, the first and second polymer layers can be of dissimilar materials of a first modulus and a second modulus, respectively, the first modulus less than the second modulus. The first and second polymer layers are therefore relatively elastic and deformable. The first and second polymer layers can also be of a material(s) with a relatively low glass transition temperature such that the first and second polymer layers ‘flow’ or ‘creep’ at relatively low temperatures and over relatively short periods of time. As described above, this material property can enable the touch layer to ‘self-heal’ as the first and/or second polymer layers flow into depressions, divots, scratches, or other damage on the touch surface adjacent the low-friction coating.

In one example implementation, the touch layer is manufactured by first lapping or grinding the substrate on each (opposing) broad face such that the substrate is of a substantially constant thickness and is suitably flat and parallel. Subsequently, the outer broad face of the substrate is activated (e.g., as described in U.S. 61/713,396) and the first polymer layer is extruded into a sheet, cut, and applied over the outer broad face of the substrate by pressing the substrate and the first polymer layer between parallel mirror polished plates, such as for a specified period of time and at a specified temperature and pressure. The second polymer layer is then extruded and applied over the first polymer layer by pressing the substrate and the first polymer layer between parallel mirror polished plates, such as for another specified period of time and at another specified temperature and pressure.

In another example implementation, the substrate is prepared as described in the foregoing example implementation, and a polymer layer (e.g., urethane) of the first modulus is applied over the outer broad face of the substrate. The polymer layer is then altered proximal the surface opposite the substrate to increase cross-linking between polymer chains in the polymer, thus yielding increased modulus in the polymer proximal the outer surface (opposite the substrate) while polymer proximal the substrate remains substantially at the first modulus. For example, x-ray bombardment, electron bombardment, or a chemical wash on the surface of the polymer opposite the substrate can break hydrogen bonds between polymers in the polymer, the density of hydrogen bonds broken during the treatment greatest near the outer surface of the polymer and decreasing through the thickness of the polymer toward the substrate. Once the hydrogen bonds between polymer strands are broken, the polymer strands can cross-link or combine, thus yielding increased polymer stand lengths, greater cross-linking between polymer strands, and therefore increased modulus and decreased elasticity proximal the outer surface of the substrate. Therefore, in this example implementation, a singular layer of polymer can be applied over the substrate and then treated such that the polymer exhibits variable modulus throughout its thickness, the polymer exhibiting greatest modulus near the outer surface of the sheet (opposite the substrate) (the “second polymer layer) and minimum modulus nearest the substrate (the “first polymer layer). Following the treatment, the outer surface of the polymer layer can be ground or lapped flat or the substrate-polymer stack can be heated between parallel mirror-polished plates to yield a substantially flat, smooth, and parallel outer surface of the polymer.

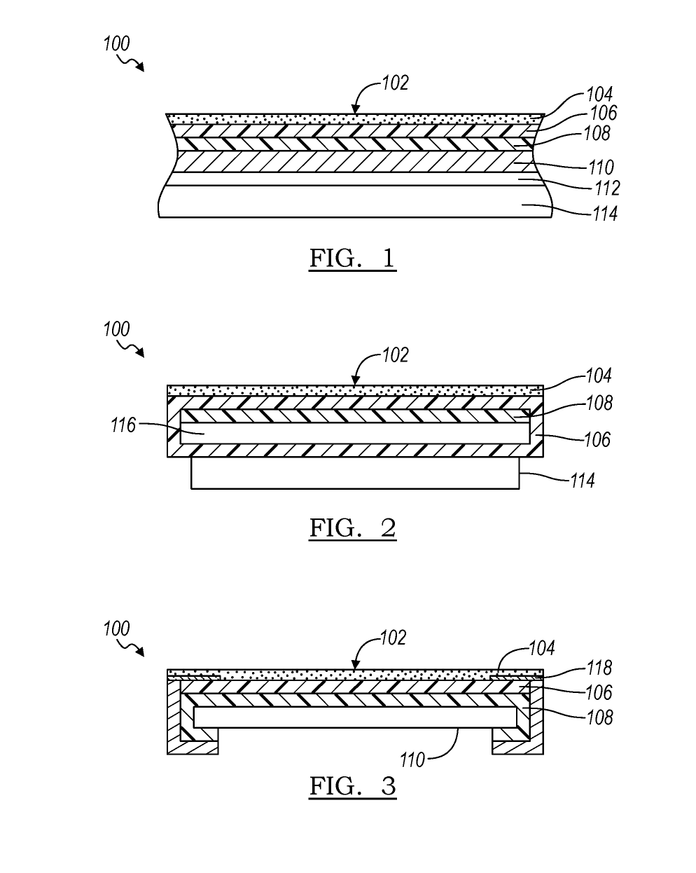

In yet another example implementation, the substrate is formed as in the foregoing implementations and the first polymer layer of the first modulus of applied over the substrate. This elastomer-substrate assembly is then encapsulated with a polymer of a second modulus greater than the first modulus, as shown in FIG. 2. In one example, the elastomer-substrate assembly is dipped in a bath of the second polymer and then set in a mirror-polished mold, first polymer layer down, to cure. In another example, the second polymer is sprayed or sputtered onto the elastomer-substrate assembly and is then cured. In yet another example, a sheet of the second polymer is wrapped around the elastomer-substrate assembly, pressed between a pair of mirror-polished parallel plates, and then trimmed to size.

As described above, the substrate can be coupled to and/or physically coextensive with the touch sensor (and/or display or touchscreen) with touch sensor terminals arranged on the back surface of the substrate. Thus, in the foregoing example implementation, the touch sensor terminals can be masked prior to coating with the second polymer and the mask subsequently removed during installation of the substrate into a mobile computing device. For example, the mask can be removed to reveal exposed touch sensor terminals, and a ribbon cable electrically coupled to a touch sensor processing unit within the mobile computing device can be connected to the exposed touch sensor terminals during assembly of the mobile computing device.

In a similar example implementation, the first and/or second polymer layers are applied across the outer broad face of the substrate and around the edge of the substrate to the back surface of the substrate. In this example implementation, encapsulation of the edge of the substrate by the first and/or second polymer layers can permit relatively low bond strength between the substrate and the first polymer layer or between the first and second polymer layers without substantially sacrificing stability of the polymer layer-substrate assembly.

In other implementations, the substrate is physically coextensive or joined to the touch sensor, the display, and/or the touchscreen of the mobile computing device, and the first and/or second polymer layers encapsulate the substrate, touch sensor, display, and/or touchscreen (excluding an electrical connection or terminal for the touch sensor, display, and/or touchscreen), as described above. Similarly, the first and/or second polymer layers extend over an edge and to the back side of (but do not fully encapsulate) the substrate, touch sensor, display, and/or touchscreen. However, the first and second polymer layers can be applied or installed over the substrate in any other suitable way.

As shown in FIG. 3, one variation of the touch layer includes an opaque region proximal the perimeter of the substrate. Generally, the opaque region covers an off-screen area of the touch sensor, display, and/or touchscreen, such as to hide touch sensor terminals and/or an electrical connector for the display.

In one implementation, the opaque region includes an opaque coating, such as a paint (e.g., black epoxy or black enamel) or a plating (e.g., nickel plate or black oxide). In this implementation, the opaque coating can be applied between first and second polymer layers, such as by masking a center area of the first polymer layer, spraying the opaque coating over the exposed are of the first polymer layer, removing the mask, and applying the second polymer layer. Alternatively, the opaque coating can be applied between the substrate and the first polymer layer or over the second polymer layer opposite the substrate, such as after assembly over the first polymer layer.

In another implementation, the opaque region includes an opaque insert. For example, the insert can be a metallic sheet (e.g., black anodized aluminum) or a polymer sheet (e.g., black nylon, white HDPE). The opaque insert can be inserted between the first and second polymer layers, between the first polymer layer and the substrate, between the substrate and the touch sensor or display, etc. Alternatively, the opaque insert can be applied over the second polymer layer prior to application of the low-friction coating. However, the opaque region can be of any other form and applied or installed in the touch layer in any other suitable way.

The low-friction coating is applied across the second polymer layer opposite the first polymer layer. Generally, the low-friction coating functions to seal the second polymer layer. As described above, the second elastomer may have a relatively low glass transition temperature and may therefore be susceptible to impregnation of dirt, moisture, skin oils, stains, and other residue into its outer surface. The low-friction coating may therefore seal the outer surface of the second polymer layer to prevent dirt, etc. from penetrating into the second polymer layer. For example, the low-friction coating may be an oleophobic material, such as a ten-molecule thick Teflon coating or ultra-high molecular weight silicone coating that sheds dirt, etc. away from the second polymer layer.

The low-friction coating also functions to define a smooth surface against which a user may supply an input, such as with a finger or stylus. For example, damage to the touch layer may be absorbed by the second polymer layer, resulting in a depression or scratch in the second polymer layer. In this example, the low-friction coating can yield substantially minimal friction between an input implement (e.g., a finger, a stylus) and the touch surface such that the input implement does not ‘catch’ a depression, or edge at the damaged area but rather glides over the damaged area. Thus, the low-friction coating can resist further damage to a damaged area of the second polymer layer by providing a low-friction buffer between the second polymer layer and the input implement. The low-friction coating can similarly protect the outer surface of the second polymer layer from general wear, scratches, and superficial impressions during user. For example, the low-friction coating can buffer the second polymer layer against a high-force and/or long-time duration input on the touch layer, thereby reducing a ghosting effect (e.g., of a fingerprint) in the second polymer layer.

The low-friction coating can be a polymer, such as Teflon coating or ultra-high molecular weight silicone coating as described above. The low-friction coating can also be substantially thin, such as 0.05 mm thick or ten-molecules thick. Furthermore, like the substrate, the first polymer layer, and the second polymer layer, the low-friction coating can be substantially transparent. The low-friction coating can be sprayed, sputtered, dip-coated, rolled, or applied over the second polymer layer in any other suitable way.

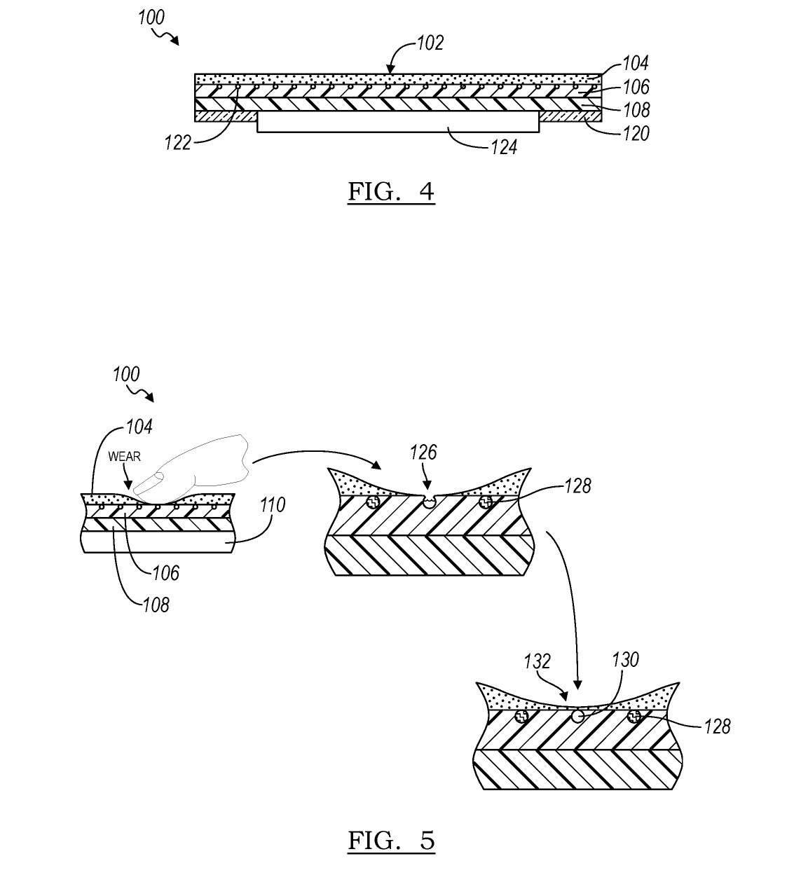

As shown in FIG. 4, one variation of the touch layer includes packets containing un-cured low-friction material and impregnated into the low-friction coating and/or into the second polymer layer. Generally, as the low-friction coating wears over time due to use, the packets are exposed, their walls burst, and un-cured low-friction material is released. Once released, the low-friction material can then disperse and cure over the worn area to provide extended protection and wear resistance to the area, as shown in FIG. 5. For example, each packet can include a thin nanospherical shell filled with un-cured or ‘wet’ Teflon diluted in a spirit. In this example, the outer surface of the second polymer layer can be covered in (thousands of) such packets prior to coating with the low-friction coating (such as Teflon). Thus, as the low-friction coating wears, packets are exposed locally.

The uncured material in the packets may cure after the packets burst in response to wear and tear due to normal usage of the device or touch. The packets may be contained in a shell of urethane and contain pockets of silicon, oil, or some other material. The uncured material is ultimately cured when the shell containing the uncured material is ruptured.

The exposed packets may cure when the packets are exposed to air. The curing in response to air exposure may be gradual enough to allow the packets to coat the surface of the touch layer, whether a polymer layer or low-friction coating, in order to repair the surface of the polymer layer or the low-friction coating.

The uncured packets may, in some instances, cure after they burst in response to wear or touch, when the packets are exposed to moisture. The curing in response to moisture exposure may be gradual enough to allow the packets to coat the surface of the touch layer, whether a polymer layer or low-friction coating, in order to repair the surface of the polymer layer or the low-friction coating.

The uncured packets may, in some instances, cure after they burst in response to wear or touch, when the packets are exposed to heat. The curing in response to heat exposure may be gradual enough to allow the packets to coat the surface of the touch layer, whether a polymer layer or low-friction coating, in order to repair the surface of the polymer layer or the low-friction coating.

Exposure to air, heat, ultraviolet light, or a secondary material stored separately from the low-friction material can cause the packets to burst or enhance diffusion of the enclosed material through the packets' shell wall and/or surrounding polymer material. Further use of the touch layer wears through the packet shells, which rupture, releasing for example an un-cured Teflon and spirit. As the spirit evaporates, the Teflon cures over the worn area, thus repairing the Teflon coating. However, the packets can be of any other form, can include any other low-fiction material or spirit, and can be arranged in any other way within the touch layer. A portion of the second polymer layer can also be substantially uncured but reflow and cure when exposed to oxygen when the first polymer layer above is punctured.

The outer surface of the touch layer may exhibit self-healing through implementation of one or more self-lubrication mechanisms. The touch layer may include an encapsulated lubricant, such as for example a silicon oil. The encapsulated lubricant may act to self-lubricate the outer surface of the touch layer, thereby providing or maintaining a smooth surface against which a user may supply an input, such as with a finger or stylus. The self-lubrication achieved by an encapsulated lubricant can yield substantially minimal friction between an input implement (e.g., a finger, a stylus) and the touch surface such that the input implement does not ‘catch’ a depression, or edge at the damaged area but rather glides over the damaged area. Thus, the encapsulated lubricant can resist further damage to a damaged area of the second polymer layer by providing a low-friction buffer between the second polymer layer and the input implement. The encapsulated lubricant can similarly protect the outer surface of the second polymer layer from general wear, scratches, and superficial impressions during user. For example, the encapsulated lubricant can buffer the second polymer layer against a high-force and/or long-time duration input on the touch layer, thereby reducing a ghosting effect (e.g., of a fingerprint) in the second polymer layer.

The touch layer may include an embedded lubricant that may diffuse over time. The diffusion may designed to occur over the lifetime of the product utilizing the touch layer. The embedded lubricant may act to self-lubricate the outer surface of the touch layer, thereby providing or maintaining a smooth surface against which a user may supply an input, such as with a finger or stylus. The self-lubrication achieved by an embedded lubricant can yield substantially minimal friction between an input implement (e.g., a finger, a stylus) and the touch surface such that the input implement does not ‘catch’ a depression, or edge at the damaged area but rather glides over the damaged area. Thus, the embedded lubricant can resist further damage to a damaged area of the second polymer layer by providing a low-friction buffer between the second polymer layer and the input implement. The embedded lubricant can similarly protect the outer surface of the second polymer layer from general wear, scratches, and superficial impressions during user. For example, the embedded lubricant can buffer the second polymer layer against a high-force and/or long-time duration input on the touch layer, thereby reducing a ghosting effect (e.g., of a fingerprint) in the second polymer layer.

In some instances, the touch layer may include a lubricant, either embedded or encapsulated, that may diffuse over time in response to heat. The diffusion may occur when a heating element applies heat to a portion of the touch layer that includes the lubricant. The heat-diffused lubricant may act to self-lubricate the outer surface of the touch layer, thereby providing or maintaining a smooth surface against which a user may supply an input, such as with a finger or stylus.

The touch layer may include a self-lubricating polymer that maintains lubrication at the surface of the touch layer over time. The self-lubricating polymer may provide and maintain a smooth surface against which a user may supply an input, such as with a finger or stylus. The self-lubrication achieved by the self-lubricating polymer can yield substantially minimal friction between an input implement (e.g., a finger, a stylus) and the touch surface such that the input implement does not ‘catch’ a depression, or edge at the damaged area but rather glides over the damaged area. Thus, the self-lubricating polymer can resist further damage to a damaged area of the second polymer layer by providing a low-friction buffer between the second polymer layer and the input implement. The self-lubricating polymer can similarly protect the outer surface of the second polymer layer from general wear, scratches, and superficial impressions during user. For example, the self-lubricating polymer can buffer the second polymer layer against a high-force and/or long-time duration input on the touch layer, thereby reducing a ghosting effect (e.g., of a fingerprint) in the second polymer layer.

As described above, the first and second polymer layers can be of materials that exhibit low glass transition temperatures and/or high rates of mechanical creep near room temperature such that the first and second polymer layers can absorb and soften damage across the outer surface of the second polymer layer.

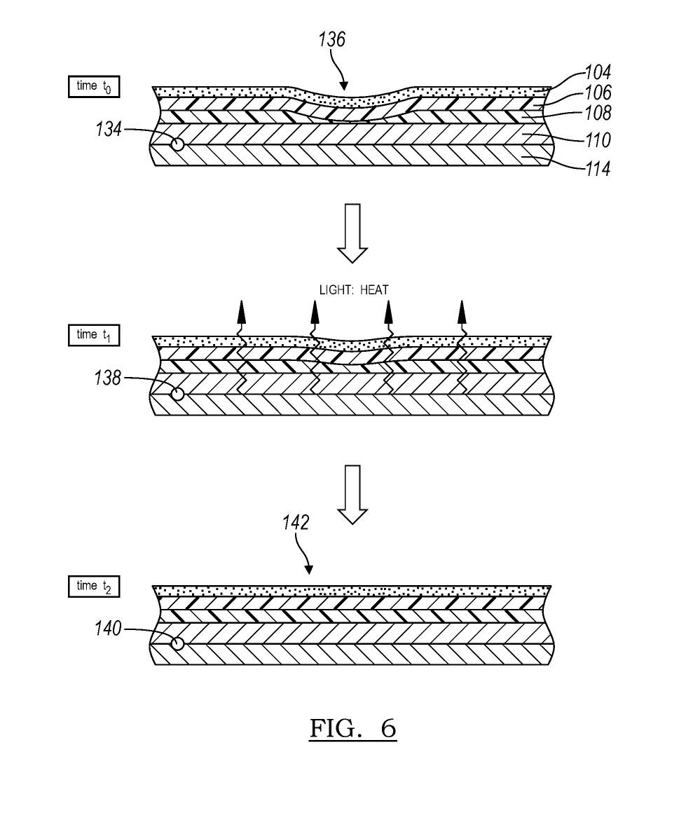

In one example implementation, the touch layer in installed over a display in a mobile computing device executing a native ‘screen repair’ application. In this implementation, when a user selects the native application, the native application directs the user to plug the mobile computing device into a charging unit (e.g., a wall adapter) and to place the mobile computing device face up on a flat surface. Once the mobile computing device confirms that the charging unit is connected and that the mobile computing device is face up on a table (e.g., based on an accelerometer and/or gyroscope output), the native application instructs the user to leave the mobile computing device without disruption for a period of time (e.g., one hour). During this period of time, the native application displays a white background on the display at full brightness. This can heat the first and second polymer layers, which soften, and gravity can cause the first and second polymer layers to absorb damage on the surface by creeping into sharp areas on the outer surface of the second polymer layer, which may be consistent with damage, as shown in FIG. 6. After a portion of the period of time (e.g., forty-five minutes), the native application can shift the display to a black screen at minimum brightness to allow the touch layer to cool and harden.

In a similar example implementation in which the touch layer in installed over a display in a mobile computing device executing a native ‘screen repair’ application, the first and/or second polymer layers can be of material(s) that softens in one lighting condition and hardens in another lighting condition. In this example implementation, the native application can set the display to output a background color fulfilling the first lighting condition to soften the first and/or second polymer layers, such as for a first period of time (e.g., thirty minutes), and then set the display to output a background color fulfilling the second lighting condition to harden the first and/or second polymer layers, such as for a second period of time (e.g., fifteen minutes). Once the repair period completes, the native application can trigger an alarm to inform the user that the repair is complete, such as by sounding an audible alarm.

The native application can also access device or screen temperatures via one or more thermistors within the mobile computing device and adjust a heating and/or cooling schedule accordingly, such as based on a repair algorithm. For example, the native application can prompt the user to select from various levels on damage on the touch surface, such as ‘light scratches,’ deep scratch,' dimple,' or ‘gouge,’ and the native application can select a heating and cooling schedule or a heating and cooling algorithm tailored to the type of damage selected by the user. For example, light scratches can require heating at a first temperature for a first period of time and a deep scratch can require heating at a first temperature greater than the first and a second period of time also greater than the first. The native application can also prompt the user to select where damage is evident on the touch layer. For example, the native application can prompt the user to run a finger over damaged area and interface with a touch sensor within the mobile computing device to identify specific damaged areas (including a specific type of damage in each selected area). In this example, the native application can selectively heat the touch layer proximal selected areas, such as by displaying a white background on the display at full brightness proximal selected areas and displaying a black background on the display proximal areas not selected as damaged.

In the foregoing example implementations, the substrate can also include fluid channel fluidly coupled to a heat source within the mobile computing device, such as a battery or a processor. As described in U.S. Provisional Application No. 61/786,300, filed on 14 Mar. 2013, which is incorporated in its entity by this reference, the native application can control a displacement device to displace heated fluid from the heat source(s) to the touch layer to heat the first and/or second polymer layers. The native application can also control activity on the processor and/or load on the battery to manipulate the temperature of the fluid pumped through the touch layer, such as based on repair algorithm as described above.

In another example implementation in which the touch layer in installed over a display in a mobile computing device executing a native ‘screen repair’ application, the native application can guide a user to repair the first and/or second polymer layers by placing the mobile computing device display-side up in direct sunlight. The native application can monitor the temperature of the display and/or touch layer by interfacing with thermistors or other temperature sensors within the mobile computing device, such as a function of time, and native application can thus trigger an (audible) alarm for the user to remove the mobile computing device from direct sunlight (and to place the mobile computing device face up undisturbed for a period of time on a horizontal surface) once a duration condition and/or a temperature condition are met.

In the foregoing example implementations, the native application can alternatively instruct a user to place the mobile computing device display-side down on a dust- and lint-free glass surface, mirror surface, or manufacturer-provided surface, (e.g., a mirror-polished metallic surface). The native application can also instruct a user to place the mobile computing device in alternative hot zone (e.g., on a warm over) to ‘reflow’ the first and/or second polymer layers or to place the mobile computing device in a cold zone, such as in a refrigerator or freezer to modulus the first and/or second polymer layers. However, the native application can prompt the user to provide any other information pertaining to damage of the first and/or second polymer layers and/or guide the user through any other action to repair damage to the first and/or second polymer layers.

Alternatively, a user can complete any one or more of the foregoing touch layer repair cycles manually and without the assistance of a native application, such as by placing the mobile computing device face-up in direct sunlight and monitoring a clock to determine when to remove the mobile computing device from the direct sunlight.

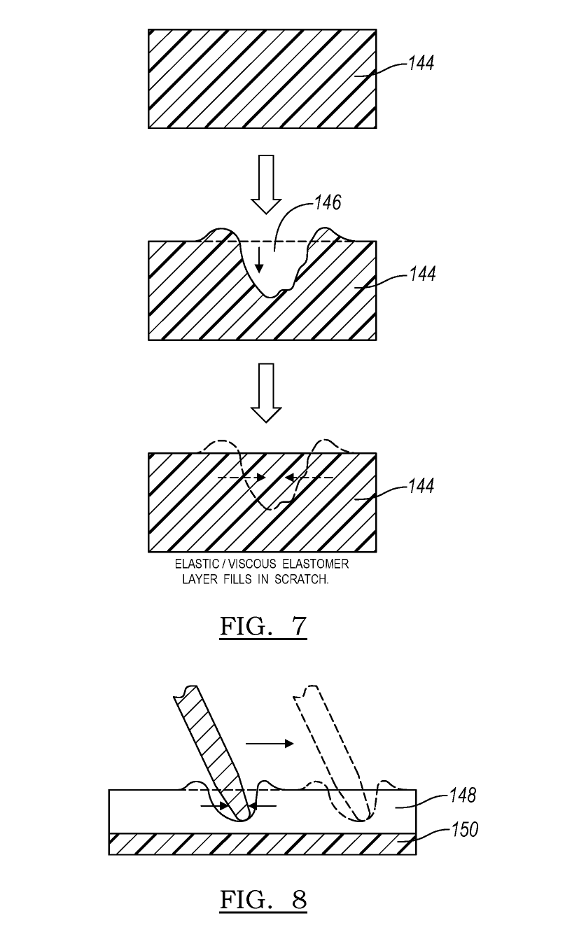

In another implementation shown in FIG. 7, the polymer layer can include a viscoelastic material (e.g., a gel or fluid) that resists permanent scratches, gouges, voids, distortions, etc. by flowing into voids in the tactile surface, such as scratches or gouges, thereby restoring the tactile surface to a substantially smooth surface. The viscoelastic material of the polymer layer can substantially resist scratches, indentations, gouges, grooves, etc. formed by an object contacting the polymer layer. When superficial damage occurs to the tactile surface, such as a scratch, groove, gouge, etc. caused by contact with an external, the viscoelastic material can flow into the void over some period of time (e.g., a day). For example, a user can stick a pin into the tactile surface, forming a gouge in the polymer layer. After the pin is removed from the surface, the viscoelastic material flows back into gouge created by the pin, thereby restoring the polymer layer to a gouge-free, substantially smooth surface, as shown in FIG. 8.

The viscoelastic material flow of a polymer layer may occur in response to heating the polymer layer. The heating may be achieved by an embedded heating element, a transparent conductor embedded in the polymer layer, a conductor embedded in a touch sensor or touch display, a display itself, or circuitry elements in a device that provides a display. The flowing within a viscoelastic material may promote recovery by filling depressions, indentations, scratches, and any other wear experienced by a surface of the touch display.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, native application, frame, iframe, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

I claim:

1. A touch layer for a mobile computing device, including:
a substrate defining a surface;
a first poloymer layer having a first modulus and arranged across the surface; and
a second polymer layer having a second modulus less than the first modulus and arranged across the first polymer layer opposite the substrate, wherein the touch layer exhibits a self-repair property to repair damage to a polymer layer.

2. The touch layer of claim 1, further comprising a low-friction coating applied across the second polymer layer opposite the first polymer layer.

3. The touch layer of claim 2, wherein the touch layer exhibits a self-repair property to repair damage to the layer.

4. The touch layer of claim 1, wherein at least one of the first polymer layer and the second polymer layer recover when heated.

5. The touch layer of claim 1, wherein at least one of the first polymer layer and the second polymer layer have a glass transition temperature that allows the layer to recover at a temperature above room temperature.

6. The touch layer of claim 1, wherein at least one of the first polymer layer and the second polymer layer or the low friction layer include packets of a lubricant that are released in response to wear and tear of the layer in which the packets are included.

7. The touch layer of claim 1, wherein at least one of the first polymer layer and the second polymer layer or the low friction layer include uncured packets that cure when exposed to air.

8. The touch layer of claim 1, wherein at least one of the first polymer layer and the second polymer layer or the low friction layer include uncured packets that cure when exposed to moisture.

9. The touch layer of claim 1, wherein at least one of the first polymer layer and the second polymer layer or the low friction layer include uncured packets that cure in response to heat.

10. The touch layer of claim 6, wherein at least one of the first polymer layer and the second polymer layer or the low friction layer include packets that release low-friction material upon an adjacent surface of the touch layer.

11. The touch layer of claim 6, wherein at least one of the first polymer layer and the second polymer layer or the low friction layer include packets that diffuse low-friction material through, into or upon a layer of the touch layer.

12. The touch layer of claim 10, wherein a content of the low friction material originally encapsulated in the packets steadily diffuse over time through the at least one of the first polymer layer and the second polymer layer or the low friction layer.

13. The touch layer of claim 10, wherein the uncured packets are impregnated within a particular layer.

14. The touch layer of claim 13, wherein the impregnated uncured packets become exposed in response to wear experienced by the particular layer.

15. The touch layer of claim 1, further including an electronically controlled heating element, the heating element applying heat to an polymer layer and causing the polymer layer to recover to near its original state.

16. The touch layer of claim 15, further including an application stored in memory of the mobile computing device and executed by a processor of the mobile computing device, the application executing to engage the heating element during a first time period to apply heat to an polymer layer, during which the polymer layer will recover to near its original state at the elastomer surface.

17. The touch layer of claim 16, wherein the first time period is proportional to the level of damage on the touch surface.

18. The touch layer of claim 16, wherein the application is executable to provide heat for a first period of time to the touch layer and a cooling to the touch layer for a second period of time, the heat softening an polymer layer and allowing the polymer layer to fill any damage to the polymer layer and the cooling allowing the softened polymer layer to cure.

19. The touch layer of claim 16, wherein the heat is applied from a display of a mobile computing device.

20. The touch layer of claim 16, wherein the heating element is embedded within the first polymer layer or the second polymer layer.

21. The touch layer of claim 16, wherein the heating element is embedded within a touch sensor.

22. The touch layer of claim 16, wherein the application is executable to provide a first lighting condition for a first period of time to the touch layer and a second lighting condition to the touch layer for a second period of time, the first lighting condition softening the polymer layer and the second lighting condition allowing the softened polymer layer to cure.

23. The touch layer of claim 16, wherein the application is configured to execute automatically based on detected use by the mobile computing device.

24. The touch layer of claim 16, wherein the application is configured to heat a sub-set of the area comprising the entire touch layer.

25. The touch layer of claim 1, further including an opaque region proximal to the perimeter of the substrate.

26. The touch layer of claim 1, further comprising a viscoelastic material that flows into voids created in the tactile surface over a period of time to return the tactile surface to near its original state.

27. A touch layer for a mobile computing device, including:
a substrate defining a surface;
a first poloymer layer having a first modulus and arranged across the surface; and
a second polymer layer having a second modulus greater than the first modulus and arranged across the first polymer layer opposite the substrate,
wherein the touch layer exhibits a self-repair property to repair damage to a polymer layer.

28. The touch layer of claim 27, further comprising a low-friction coating applied across the second polymer layer opposite the first polymer layer.

29. The touch layer of claim 28, wherein the touch layer exhibits a self-repair property to repair damage to the layer.

30. The touch layer of claim 27, wherein at least one of the first polymer layer and the second polymer layer recover when heated.

31. The touch layer of claim 27, wherein at least one of the first polymer layer and the second polymer layer have a glass transition temperature that allows the layer to recover at a temperature above room temperature.

32. The touch layer of claim 27, wherein at least one of the first polymer layer and the second polymer layer or the low friction layer include uncured packets that burst in response to wear and tear.
